(19) United States
(12) Patent Application Publication
(10) Pub. No.: US 2004/0151166 A1
(43) Pub. Date: Aug. 5, 2004

(54) Packet communication system, network device and method of managing resource employed therefor

(76) Inventors: Tsutomu Tsukagoshi, Tokyo (JP); Naoto Suzuki, Tokyo (JP); Kazushi Saeki, Tokyo (JP); Toshio Mori, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/768,082

(22) Filed: Feb. 2, 2004

(30) Foreign Application Priority Data
Feb. 5, 2003 (JP) 027718/2003

(51) Int. Cl. H04L 12/66

(52) U.S. Cl. 370/352

(57) ABSTRACT

A network device is provided which is capable of contributing to construction of a system without a centralized resource management function, ensuring system expandability to install additional call control processors, and isolating a capability of each user data processing unit from a call control section. Each of the user data processing units manages by themselves resources of their own circuits, and when responding to a call setup request sent from a C-plane for establishment of a session, and when responding to a call release request sent from the C-plane for release of the session, and also when responding to a health check signal from the C-plane, each of the user data processing units notifies the C-plane of an available resource ratio of its own circuit by attaching it to a response message. The C-plane stores thus obtained available resource ratios of each of the user data processing units, and selects the user data processing unit having remaining resources thereby to send the call setup request thereto in order to establish the session.

### BACKGROUND OF THE INVENTION

1. Field of the Invention

The present invention relates to a packet communication system, a network device and a method of managing resources employed therefor, and more particularly, to a method of managing resources in a packet communication system.

2. Description of the Prior Art

A conventional packet communication system basically comprises, as shown in FIG. 7, a mobile unit 3, a Node-B (Radio Base Station) 4, an RNC (Radio Network Controller) 5, a GGSN (Gateway GPRS Support Node) 7, a Web server 8, an SGSN [Serving GPRS (General Packet Radio Service) Support Node] 9, an IP (Internet Protocol) network 100, and an ISP (Internet Service Provider) or office LAN (Local Area Network) 200 (e.g., see 3GPP TS23.060 V3.14.0 (2002-12), Chapter 5.4 “Logical Architecture”).

The SGSN 9 located between the RNC 5 and GGSN 7 has a function for encapsulating user data to relay it in a packet communication carried out between a moving user and the Web server 8 and the like provided in the ISP or office LAN 200. The encapsulating is performed based on a GTP (GPRS Tunneling Protocol).

The SGSN 9 serves as a core network node in the packet communication system, in which a C-plane (call control section) comprises a plurality of call processors 92 and 93, a load distribution unit 91 for distributing signals thereto, a resource management processor 94, and a maintenance operation unit 95 providing a maintenance function, and a U-plane comprises user data processing units 96 to 98. The C-plane is operable for controlling signalling, and the U-plane is operable for transferring user data (e.g., see 3GPP TS23.060 V3.14.0 (2002-12), chapter 5.6 “User and Control Planes”).

The resource management processor 94 has a memory 941 for storing whether each of the user data processing units 96 to 98 has resources. The user data processing units 96, 97 and 98 are provided with GTP protocol parts 961, 971, and 981, respectively, for encapsulating and decapsulating user data.

Upon restart of the packet communication system, the resource management processor 94 recognizes the presence of all the user data processing units 96 to 98 existing in the system. This is done by either one of a notification method of sending a message from the user data processing units 96 to 98 to the resource management processor 94 or a method of reading out the presence of the user data processing units 96 to 98 from a database managed by the resource management processor 94 that has stored therein all the user data processing units 96 to 98 existing in the system.

The resource management processor 94 reserves an area in the memory 941 for storage of resources in all the user data processing units 96 to 98 existing in the system.

Upon receipt of a call setup signal, the call processor 92 requests the resource management processor 94 to specify the user data processing unit and to reserve its band and session. The resource management processor 94 ascertains resource information of the user data processing units 96 to 98 which is stored in the memory 941, and determines whether the requested band and session can be reserved.

If both are reservable, the resource management processor 94 selects the user data processing unit 96, stores the reserved resources in the memory 941, and returns information of the reserved resources to the call processor 92. Upon receipt thereof, the call processor 92 sends a call setup request to the GTP protocol part 961 in the user data processing unit 96.

Upon receipt of a call release signal, the call processor 92 specifies the user data processing unit 96 which is active, in accordance with call control information stored in the call processor 92, and then sends a release request to the specified user data processing unit 96 and its GTP protocol part 961. The call processor 92 thereafter sends a resource release request to the resource management processor 94 in order to release the band and session of the user data processing unit 96. The resource management processor 94 releases the band and session for the relevant call stored in the memory 941 upon receipt of the resource release request from the call processor 92.

An ATM (Asynchronous Transfer Mode) is a packet communication technique, in which, similarly to the above, a band managing storage device is provided together with a call processing control function (e.g., see Japanese Patent Laid-Open No. 2000-4234).

The foregoing conventional resource management technique, however, has a disadvantage because it requires a resource management processor on which signals from a plurality of call processors are concentrated, and when the call processors are additionally installed, the resource management processor will be no longer able to process all signals, consequently limiting the system expandability.

The conventional resource management technique also encounters a problem because the resource management processor responsible for centralized control of processing bands and the number of processing sessions for all the user data processing units must work on matching and linking of information between the call control section and user data processing units each having different capability if installed onto the system. The same problem resides also in the art disclosed in the above Patent Document.

Therefore, an object of the present invention is to solve the foregoing problems and to provide a packet communication system that is configurable with no centralized resource management function and is capable of ensuring system expandability to install additional call control processors and isolating the capability of each of the user data processing units from the call control section, and also to provide a network device and a method of managing resources employed therefor.

### SUMMARY OF THE INVENTION

The present invention is directed to a packet communication system performing packet communication in which incoming and outgoing calls are controlled at call control means and user data is encapsulated and decapsulated at user data processing means, the system comprising resource management means for managing resources of the user data processing means, the resource management means being provided in the user data processing means.

The present invention is also directed to a network device performing packet communication by controlling incoming and outgoing calls at call control means and by encapsulating and decapsulating user data at user data processing means, the device comprising resource management means for managing resources of the user data processing means, the resource management means being provided at the user data processing means.

The present invention is furthermore directed to a method of managing resources of a network device performing packet communication by controlling incoming and outgoing calls at call control means and by encapsulating and decapsulating user data at user data processing means, wherein the user data processing means executes a step of managing resources of the user data processing means.

According to the packet communication system of the present invention, a network device in the system is so configured that a call control section (C-plane) comprising a plurality of processors is logically and physically separated from a plurality of user data processing units and that the call control section does not manage (capture and release) band resources and the number-of-sessions resources of the user data processing units.

Also, according to the packet communication system of the present invention, each of the user data processing units manages (captures and releases) by itself its own band resources and the number-of-sessions resources.

Furthermore, according to the packet communication system of the present invention, when responding to a call setup request sent from the call control part to the user data processing unit in order to establish a session, the user data processing unit notifies the call control section of a status of the remaining band and number of sessions (indicated by an available resource ratio representing a ratio of the remaining band and number of sessions to resources, hereinafter referred to as an available resource ratio) by attaching it to a response message for the call control section.

Moreover, according to the packet communication system of the present invention, when responding to a call release request sent from the call control section to the user data processing unit in order to release the session, the user data processing unit notifies the call control section of its own available resource ratio by attaching it to a response message for the call control section.

When the user data processing unit responds to a health check signal that is sent from the call control section in order to check a condition (operable or not) of the user data processing unit, the user data processing unit notifies the call control section of its own available resource ratio by attaching it to a response message for the call control section.

The call control section stores the available resource ratios of each of the user data processing units acquired in the foregoing processing, and selects the user data processing unit having the remaining resources thereby to send thereto the call setup request for establishment of the session.

The capability of the user data processing unit has heretofore been closely managed by a centralized resource management function provided to the call control section, and both capturing and releasing of resources in the user data processing unit have also been controlled by this function.

The packet communication system of the present invention is, however, so designed as to eliminate the need for the call control section to closely recognize the band and number of sessions of the user data processing unit, therefore the centralized resource management function providing close resource management is no longer necessary.

In the prior art, the centralized resource management function is by its nature engaged in processing signals from a plurality of call control sections, thus causing a bottleneck in extending system capability. The packet communication system of the present invention, however, does not require this centralized resource management function, which leads to a greater potential for system expandability.

When a plurality of user data processing units have each different capability associated with available bands and sessions, the call control section has conventionally required the centralized resource management function to recognize the capability of each of the user data processing units.

However, the packet communication system of the present invention allows each call control section to recognize only remaining resources of each of the user data processing units, therefore the call control section no longer needs to recognize the capability of each of the user data processing units. Accordingly, it is possible to easily construct a system using user data processing units each having different capability.

Thus, since the packet communication system of the present invention eliminates the function of closely managing resources from the call control section, it no longer needs to have the centralized resource management function, thereby enabling construction of a system with less processors.

Furthermore, the packet communication system of the present invention does not require the centralized resource management function, preventing a processing bottleneck caused by a specific processor even in installing additional call processors for expansion of the system capability.

Moreover, in the packet communication system of the present invention, the user data processing unit manages by itself its own resources. This eliminates the need for the call control section to be explicitly conscious of the capability of each of the user data processing units, so that the user data processing units each having different capability can be installed with one another in the network device.

### BRIEF DESCRIPTION OF THE DRAWINGS

FIG. 1 is a block diagram showing a configuration of a network device according to a preferred embodiment of the present invention;

FIG. 2 is a block diagram showing a configuration of a packet communication system according to an example of the present invention;

FIG. 3 is a sequence chart showing operations of the packet communication system according to the example of the present invention;

FIG. 4 is a sequence chart showing the operations of the packet communication system according to the example of the present invention;

FIG. 5 is a sequence chart showing the operations of the packet communication system according to the example of the present invention;

FIG. 6 is a sequence chart showing the operations of the packet communication system according to the example of the present invention; and

FIG. 7 is block diagram showing a configuration of a conventional packet communication system.

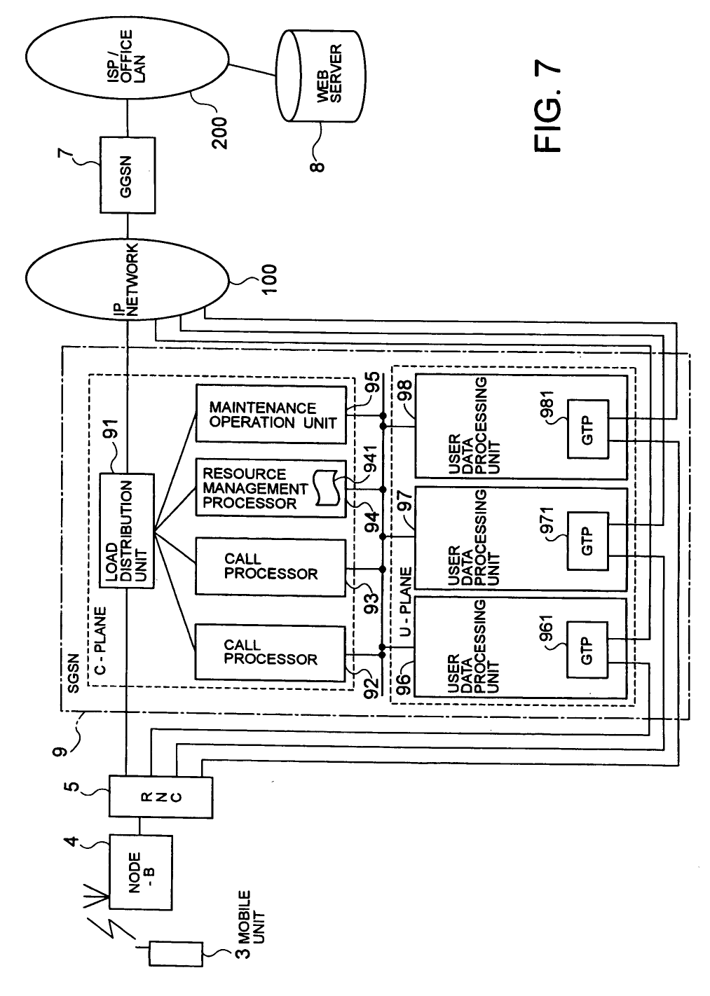

### DETAILED DESCRIPTION OF THE PREFERRED EMBODIMENTS

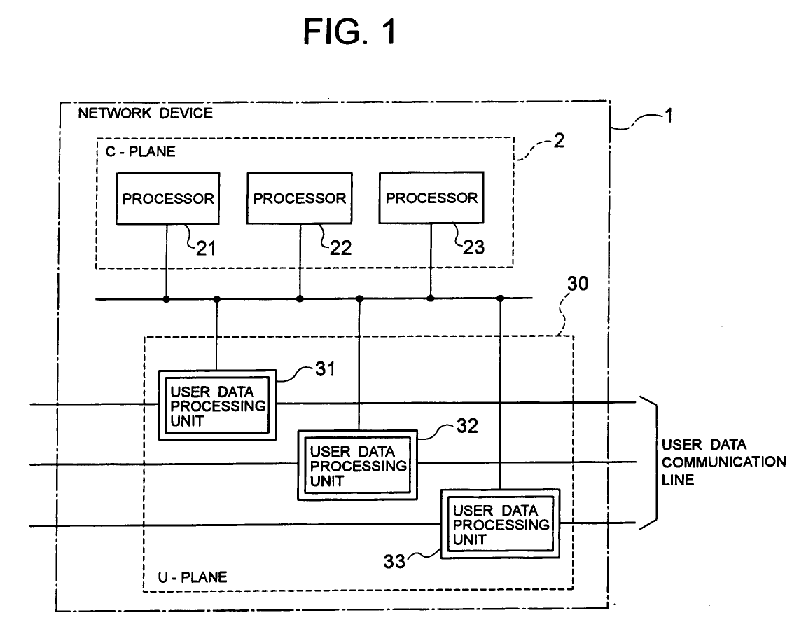

Referring now to the accompanying drawings, a preferred embodiment of the present invention will be described. FIG. 1 is a block diagram showing a configuration of a network device according to the embodiment of the present invention. As observed therefrom, the network device 1 comprises a C-plane (call control section) 2 consisting of a plurality of processors 21 to 23, and a U-plane 30 consisting of a plurality of user data processing units 31 to 33. The C-plane 2 is operative for controlling signalling, and the U-plane 30 is operative for transferring user data.

In the network device 1, the C-plane 2 and the plurality of user data processing units 31 to 33 are logically and physically separated from each other so that the C-plane 2 does not manage (capture or release) band resource and the number-of-sessions resource of the user data processing units 31 to 33.

More specifically, each of the user data processing units 31 to 33 manages (captures and releases) the band resource and the number-of-sessions resource of its own circuit. Furthermore, when responding to a call setup request sent from the C-plane 2 in order to establish a session, each of the user data processing units 31 to 33 notifies the C-plane 2 of a status of the remaining band and number of sessions of its own circuit by attaching it to a response message. This status is indicated by an available resource ratio that represents a ratio of the remaining band and number of sessions to resources, and is hereinafter referred to as an available resource ratio.

Moreover, when responding to a call release request sent from the C-plane 2 in order to release a session, each of the user data processing units 31 to 33 notifies the C-plane 2 of the available resources ratio of its own circuit by attaching it to a response message.

In addition, when responding to a health check signal sent from the C-plane 2 in order to check whether the circuit of each of the user data processing units 31 to 33 is operable or not, each of the user data processing units 31 to 33 notifies the C-plane 2 of the available resource ratio of its own circuit by attaching it to a response message.

The C-plane 2 stores thus obtained available resource ratios of each of the user data processing units 31 to 33, and selects the user data processing units 31 to 33 having remaining resources thereby to send a call setup request thereto for establishment of a session.

FIG. 1 shows that processors 21 to 23 in the C-plane 2 are connected with the user data processing units 31 to 33 based on bus topology, however, switch topology is also applicable to connect them in which case the C-plane 2 has connection through switches to all the user data processing units 31 to 33.

The capability of each of the user data processing units 31 to 33 has heretofore been closely managed by a centralized resource management function provided to the C-plane 2, and both capturing and releasing of resources in the user data processing units 31 to 33 have also been controlled by this function.

This embodiment is so designed as to eliminate the need for the C-plane 2 to closely recognize the band and number of sessions of the user data processing units 31 to 33, therefore the centralized resource management function is no longer necessary.

In the prior art, the centralized resource management function is, by its nature, engaged in processing signals from a plurality of call control sections, thus causing a bottleneck in extending system capability. This embodiment, however, does not require this centralized resource management function, which leads to a greater potential for system expandability.

When the plurality of user data processing units 31 to 33 have each different capability associated with available bands and sessions, the call control section has conventionally required the centralized resource management function to recognize the capability of each of the user data processing units.

However, this embodiment allows the C-plane 2 to recognize only the above-described remaining resources of each of the user data processing units 31 to 33, therefore the C-plane 2 no longer needs to recognize the capability of each of the user data processing units 31 to 33. Accordingly, it is possible to easily construct a system using user data processing units 31 to 33 each having different capability.

Thus, since this embodiment eliminates the function of closely managing resources from the C-plane 2, it no longer needs to have such a resource management processor as the conventional one, thereby enabling construction of a system with less processors.

Furthermore, this embodiment does not require such a resource management processor as the conventional one, preventing a processing bottleneck caused by a specific processor even in installing additional call processors for expansion of the system capability.

Moreover, in this embodiment, the user data processing units 31 to 33 closely manage by themselves their own resources. This eliminates the need for the C-plane 2 to be explicitly conscious of the capability of each of the user data processing units 31 to 33, so that the user data processing units 31 to 33 each having different capability can be mounted with one another in the network device 1.

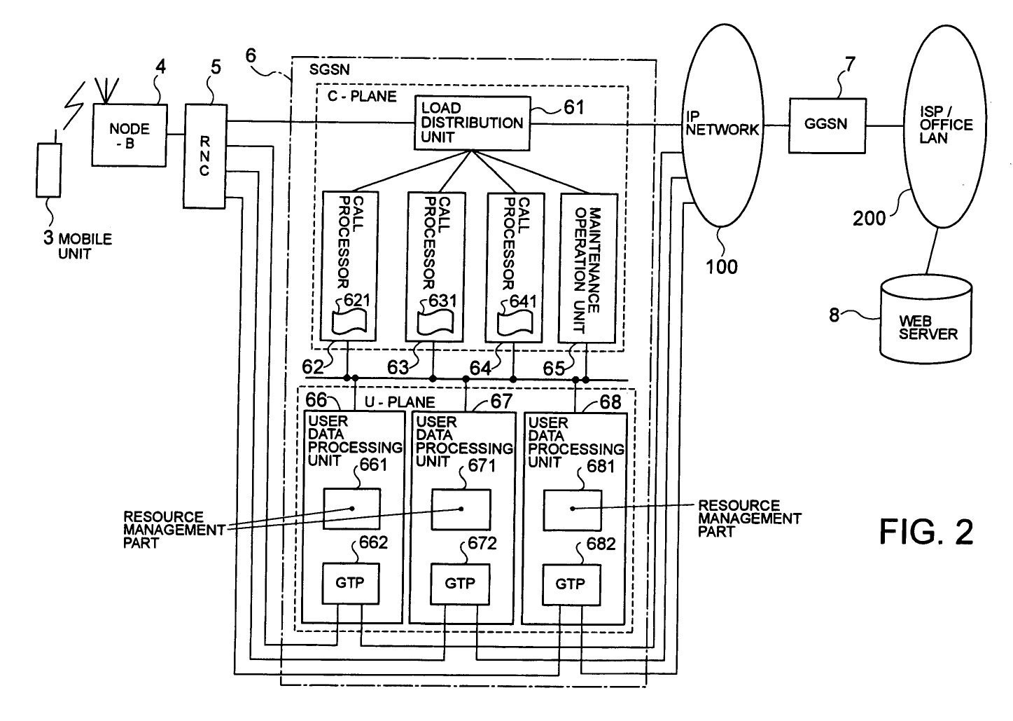

FIG. 2 is a block diagram showing a configuration of a packet communication system according to an example of the present invention. As apparent from FIG. 2, shown is a structure of an SGSN [Serving GPRS (General Packet Radio Service) Support Node] 6 in the packet communication system of a mobile communication network according to the example of the present invention.

The SGSN 6 is located between an RNC (Radio Network Controller) 5 and a GGSN (Gateway GPRS Support Node) 7, and is responsible for relaying user data while encapsulating it in a packet communication performed between a moving user (mobile unit 3) and a Web server 8 and the like provided in an ISP (Internet Service Provider) or office LAN (Local Area Network) 200. The encapsulating is carried out based on a GTP (GPRS Tunneling protocol).

Though the SGSN 6 and the GGSN 7 are directly connectable with each other, they are generally connected via a backbone network constructed by an IP (Internet Protocol) network 100.

The configuration of the foregoing packet communication system and protocols utilized therefor are defined in 3GPP (3^{rd} Generation Partnership Project) TS23.060 V3.14.0 (2002-12), chapter 5.4 and TS29.060 V3.15.0 (2002-12), Chapter 5.6 “User and Control Planes”, which provide international standards for third generation mobile communication. The RNC 5, the GGSN 7, and a Node B (radio base station) 4 are also defined by 3GPP with regard to their functionality, so the descriptions thereof will be omitted.

In order to realize packet communication between the mobile unit 3 and the Web server 8, the SGSN 6 comprises a C-plane (call control section) communicating with the RNC 5/GGSN 7, and a U-plane having user data processing units 66 to 68.

The user data processing units 66 to 68 each decapsulate the GTP encapsulated user data transmitted from the RNC 5, and encapsulate it again to send for the GGSN 7. To the contrary, the user data processing units 66 to 68 each decapsulate GTP encapsulated user data transmitted from the GGSN 7, and encapsulate it again to send for the RNC 5.

The C-plane comprises a plurality of call processors 62 to 64, a load distribution unit 61 for distributing signals thereto, and a maintenance operation unit 65 providing a maintenance capability. The call processors 62, 63 and 64 have memories 621, 631 and 641, respectively, for storing the available resources ratio in each of the user data processing units 66 to 68.

The user data processing units 66, 67 and 68 comprise resource management parts 661, 671 and 681, and GTP protocol parts 662, 672, 682, respectively. The resource management parts 661, 671 and 681 are operable for managing a status of band resources and the number-of-sessions resources in use of the circuits of the corresponding user data processing units and for capturing and releasing resources in response to a request from the C-plane. The GTP protocol parts 662, 672 and 682 are operable for encapsulating and decapsulating user data.

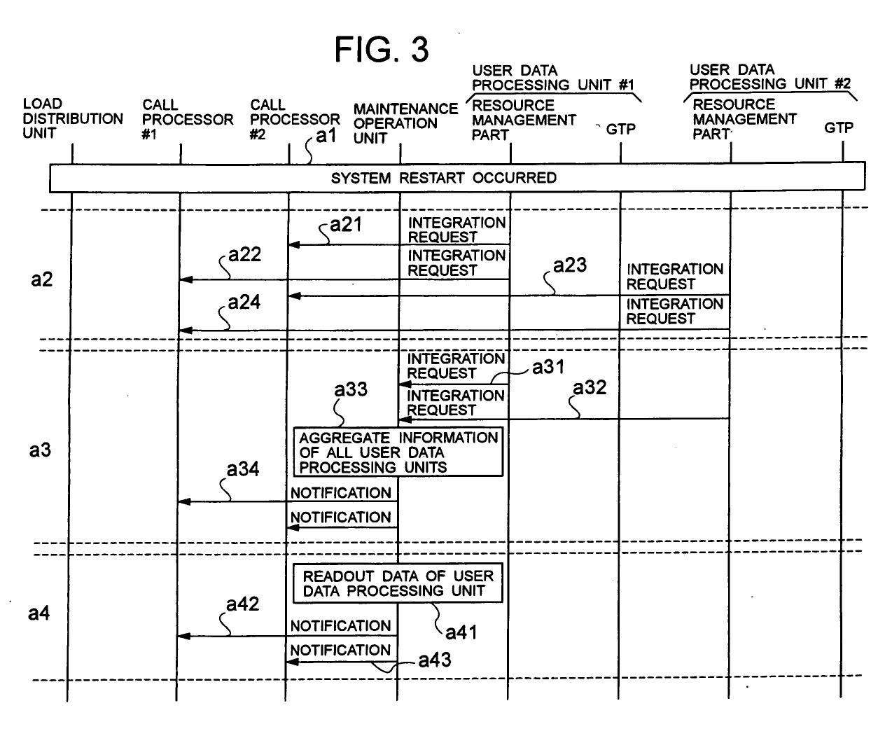

FIGS. 3 to 6 are sequence charts showing operations of the packet communication system according to the example of the present invention. Referring now to FIGS. 2 to 6, description will be made for the operations of the packet communication system according to the example of the present invention.

Upon restart of the system (a1 of FIG. 3), the call processor 62 recognizes the presence of all the user processing units 66 to 68 existing in the system (a2 of FIG. 3) by broadcast from the user data processing units 66 to 68 (a21 to a24 of FIG. 3).

Alternatively, when the maintenance operation unit 65 notifies (a33 to a35 of FIG. 3) all the call processors 62 to 64 in the system of signals (a31, a32 of FIG. 3) sent from the user data processing units 66 to 68 to the maintenance operation unit 65, the call processor 62 recognizes the presence of all the user data processing units 66 to 68 existing in the system (a3 of FIG. 3).

Alternatively, when the maintenance operation unit 65 reads out the presence of all the user data processing units 66 to 68 existing in the system that is stored in a database (not shown) managed by the maintenance operation unit 65 (a41 of FIG. 3) and then notifies all the call processor 62 to 64 (a42, a43 of FIG. 3) of it, the call processor 62 recognizes the presence of all the user data processing units 66 to 68 in the system (a4 of FIG. 3).

The call processor 62 reserves an area in the memory 621 for storage of available resources ratios (hereinafter, referred to as remaining resource information) of all the user data processing units 66 to 68 existing in the system. Although not shown, other call processors 63 and 64 also perform the same processing as the call processor 62, that is, they reserve areas in the memories 631 and 641, respectively, for storage of remaining resource information of all the user data processing units 66 to 68 existing in the system.

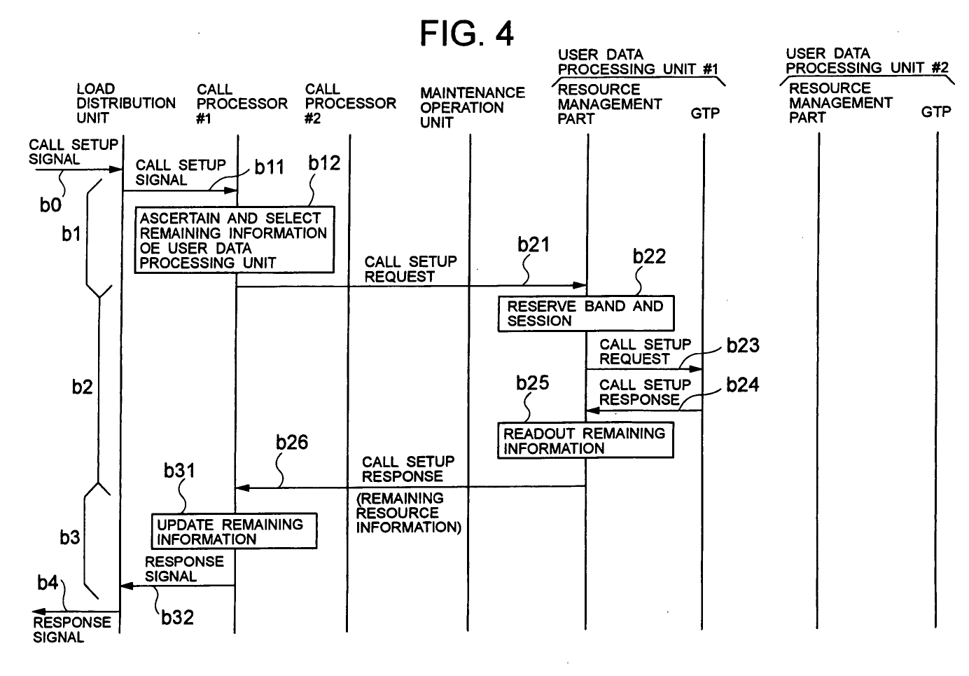

Upon receipt of a call setup signal (b0, b1 of FIG. 4), the call processor 62 ascertains the remaining resource information of each of the user data processing units 66 to 68 which is stored in the memory 621 thereby to select a user data processing unit having more remaining resources (user data processing unit 66 has the most remaining resources herein) (b12 of FIG. 4), and then sends a call setup request to the selected user data processing unit 66 (b21 of FIG. 4).

Upon receipt of the call setup request, the user data processing unit 66 determines at the resource management part 661 whether the requested band and session are reservable (b22 of FIG. 4). If reservable, the resource management part 661 sends the call setup request to the GTP protocol part 662. (b23 of FIG. 4).

Upon receipt of a call setup response from the resource management part 661 (b24 of FIG. 4), the user data processing unit 66 reads out the latest remaining resource information from the resource management part 661 (b25 of FIG. 4), prepares a response signal for the call processor 62, and then notifies the call processor 62 of the readout remaining resource information of its own circuit by attaching it to the response message (b26 of FIG. 4).

Upon receipt of the response signal to the call setup request, the call processor 62 fetches the attached remaining resource information of the user data processing unit 66, and updates the remaining resource information of each of the user data processing units 66 to 68 which is stored in the memory 621 (b31 of FIG. 4).

If the received response signal to the call setup request is a positive response, the call processor 62 stores in the memory 621 identification information of the user data processing unit 62 as call control information. Although not shown, other call processors 63 and 64 perform the same processing as the call processor 62.

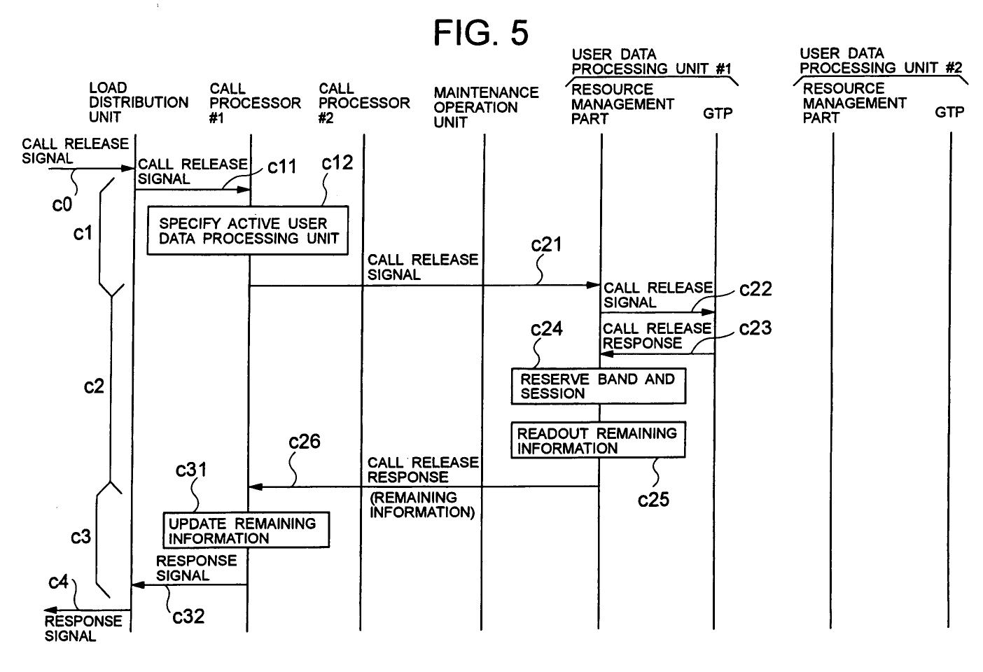

Next, upon receipt of a call release request (c0, c11 of FIG. 5), the call processor 62 specifies the active user data processing unit 66 in accordance with the call control information stored in the memory 621 (c12 of FIG. 5), and then sends a call release request to the specified user data processing unit 66 (c21 of FIG. 5).

Upon receipt of the call release request, the user data processing unit 66 sends the call release request to the GTP protocol part 662 (c22 of FIG. 5). When a call release response is obtained from the GTP protocol part 662 (c23 of FIG. 5), the user data processing unit 66 releases the band and number of sessions at the resource management part 661 (c24 of FIG. 5).

The user data processing unit 66 also reads out the latest remaining resource information from the resource management part 661 (c25 of FIG. 5), prepares a response signal for the call processor 62, and then notifies the call processor 62 of the readout remaining resource information of its own circuit by attaching it to the response message (c26 of FIG. 5).

Upon receipt of the response signal to the call release request, the call processor 62 fetches the attached remaining resource information of the user data processing unit 66, and updates the remaining resource information of each of the user data processing units 66 to 68 which is stored in the memory 621 (c31 of FIG. 5).

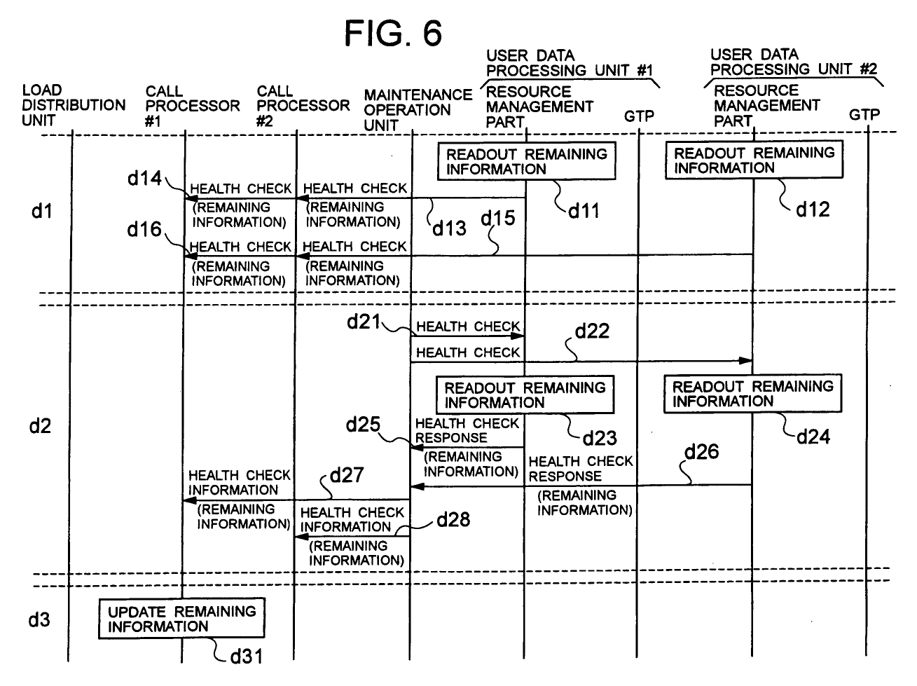

Meanwhile, when the call processor 62 receives a health check signal readout and directly transmitted from the resource management parts 661, 671 and 681 of the user data processing units 66, 67 and 68, respectively (d11 to d16 of FIG. 6) (d1 of FIG. 6), the call processor 62 fetches the remaining resource information of the user data processing units 66 to 68 that is transmitted together with the health check signal, and then updates the remaining resource information of each of the user data processing units 66 to 68 which is stored in the memory 621 (d31 of FIG. 6) (d3 of FIG. 6).

Or alternatively, when the maintenance operation unit 65 performs health checking of the user data processing units 66 to 68 (d21, d22 of FIG. 6) and thereafter transmits to the call processor 62 the health check information read out from the resource management parts 661, 671 and 681 of the user data processing units 66, 67 and 68, respectively (d23 to d28 of FIG. 6) (d2 of FIG. 6), the call processor 62 fetches the remaining resource information of the user data processing units 66 to 68 that is transmitted together with the health check information from the maintenance operation unit 65, and then updates the remaining resource information of each of the user data processing units 66 to 68 which is stored in the memory 621 (d31 of FIG. 6) (d3 of FIG. 6).

Thus, in this embodiment, the resource management function is provided to each of the user data processing units 66 to 68 so that the call processors 62, 63 and 64 may store only the remaining bands in memories 621, 631 and 641, respectively. Therefore, the system can easily be constructed without a centralized resource management function. Furthermore, system expandability to install additional call processors can be ensured and the capability of each of the user data processing units 66 to 68 can be isolated from the call processors 62 to 64.

This embodiment has shown the case in which the call processors 62, 63 and 64 store in memories thereof 621, 631 and 641, respectively, the remaining resource information of the user data processing units 66 to 68, however, it is also allowable not to store the remaining resource information. This is realized when the call processors 62 to 64 simply select one of the plurality of user data processing units 66 to 68 in a sequential manner, through call setup processing sequences.

By this, the call processors 62 to 64 no longer need to acquire the latest remaining resource information from the user data processing units 66 to 68 upon call setting and releasing or health checking.

This embodiment has dealt with the case in which the foregoing processing procedure is applied to the SGSN 6, however, it is also applicable to the GGSN 7 which is another packet switch node in a mobile communication packet network, the RNC 5 which is another node in a mobile communication network, or an MSC (Mobile Switching Center) which is a node in a mobile communication line switching network.

As described above, the present invention provides the foregoing constitution and operations and thereby offers several advantages such that a system can easily be constructed without the centralized resource management function, and system expandability to install additional call control processors can be ensured, and furthermore the capability of each user data processing unit can be isolated from the call control section (C-plane).

What is claimed is:

1. A packet communication system performing packet communication in which incoming and outgoing calls are controlled at call control means and user data is encapsulated and decapsulated at user data processing means, comprising:
resource management means for managing resources of the user data processing means, the resource management means being provided in the user data processing means.

2. The packet communication system according to claim 1, wherein the resource management means manages at least an available resource ratio indicating a ratio of remaining bands and the number of remaining sessions relative to band resources and the number-of-sessions resources of the user data processing means.

3. The packet communication system according to claim 2, wherein the call control means comprises storage means for storing the available resource ratio of the user data processing means that is notified from the resource management means.

4. The packet communication system according to claim 2, wherein the user data processing means attaches the available resource ratio to a response signal for the call control means and then sends the resulting response signal to the call control means.

5. The packet communication system according to claim 4, wherein the user data processing means attaches the available resource ratio to a response message for a call setup request sent from the call control means in order to establish a session, and then sends the resulting response message to the call control means.

6. The packet communication system according to claim 4, wherein the user data processing means attaches the available resource ratio to a response message for a call release request sent from the call control means in order to release the session, and then sends the resulting response message to the call control means.

7. The packet communication system according to claim 4, wherein the user data processing means attaches the available resource ratio to a response message for a health check signal sent from the call control means in order to check a condition of the user data processing means, and then sends the resulting response message to the call control means.

8. The packet communication system according to claim 2, wherein the call control means selects the user data processing means having remaining resources in accordance with the available resource ratio, and sends the call setup request for establishment of the session to the selected user data processing means.

9. A network device performing packet communication by controlling incoming and outgoing calls at call control means and by encapsulating and decapsulating user data at user data processing means, comprising:
resource management means for managing resources of the user data processing means, the resource management means being provided in the user data processing means.

10. The network device according to claim 9, the resource management means manages at least an available resource ratio indicating a ratio of remaining bands and the number of remaining sessions relative to band resources and the number-of-sessions resources of the user data processing means.

11. The network device according to claim 9, wherein the call control means comprises storage means for storing the available resource ratio of the user data processing means that is notified from the resource management means.

12. The network device according to claim 10, wherein the user data processing means attaches the available resource ratio to a response signal for the call control means and then sends the resulting response signal to the call control means.

13. The network device according to claim 12, wherein the user data processing means attaches the available resource ratio to a response message for a call setup request sent from the call control means in order to establish a session, and then sends the resulting response message to the call control means.

14. The network device according to claim 12, wherein the user data processing means attaches the available resource ratio to a response message for a call release request sent from the call control means in order to release the session, and then sends the resulting response message to the call control means.

15. The network device according to claim 12, wherein the user data processing means attaches the available resource ratio to a response message for a health check signal sent from the call control means in order to check a condition of the user data processing means, and then sends the resulting response message to the call control means.

16. The network device according to claim 10, wherein the call control means selects the user data processing means having remaining resources in accordance with the available resource ratio, and transmits the call setup request for establishment of the session to the selected user data processing means.

17. A method of managing resources for a network device performing packet communication by controlling incoming and outgoing calls at call control means and by encapsulating and decapsulating user data at user data processing means, wherein
the user data processing means executes a step of managing resources of the user data processing means.

18. The method of managing resources according to claim 17, wherein the step of managing resources includes managing at least an available resource ratio indicating a ratio of remaining bands and the number of remaining sessions relative to band resources and the number-of-sessions resources of the user data processing means.

19. The method of managing resources according to claim 18, wherein the call control means executes a step of storing in storage means thereof the available resource ratio of the user data processing means that is notified by the step of managing resources.

20. The method of managing resources according to claim 18, wherein the user data processing means attaches the available resource ratio to a response signal for the call control means and then sends the resulting response signal to the call control means.

21. The method of managing resources according to claim 20, wherein the user data processing means attaches the available resource ratio to a response message for a call setup request sent from the call control means in order to establish a session, and then sends the resulting response message to the call control means.

22. The method of managing resources according to claim 20, wherein the user data processing means attaches the available resource ratio to a response message for a call release request sent from the call control means in order to release the session, and then sends the resulting response message to the call control means.

23. The method of managing resources according to claim 20, wherein the user data processing means attaches the available resource ratio to a response message for a health check signal sent from the call control means in order to check a condition of the user data processing means, and then sends the resulting response message to the call control means.

24. The method of managing resources according to claim 18, wherein the call control means selects the user data processing means having remaining resources in accordance with the available resource ratio, and transmits the call setup request for establishment of the session to the selected user data processing means.
